(19) United States
(12) Patent Application Publication
(10) Pub. No.: US 2024/0417186 A1
(43) Pub. Date: Dec. 19, 2024

(54) AUGER HOPPER SYSTEM AND PARTS THEREFOR

(71) Applicant: NEERALTA MANUFACTURING INC., County of Barrhead (CA)

(72) Inventor: John Marvin Wierenga, County of Barrhead (CA)

(21) Appl. No.: 18/652,333

(22) Filed: May 1, 2024

Related U.S. Application Data
(60) Provisional application No. 63/507,789, filed on Jun. 13, 2023.

(51) Int. Cl. B65G 47/18; B65D 88/54; B65G 33/14

(52) U.S. Cl. CPC B65G 47/18; B65D 88/54; B65G 33/14

(57) ABSTRACT

Hopper system including detachable plates suitable for use with grain auger tubes of different sizes. A detachable, generally U-shaped plate is attached to the hopper and receives an auger tube of predetermined size, such that the auger tube makes contact with the U-shaped edge of the plate. The plate is selected from a plurality of plates configured for auger tubes of different sizes. To switch the hopper from one auger to another of a different size, the attached plate is detached from the hopper and a different plate is attached. In some embodiments, the auger extends through a tail end of the hopper and secured outside the hopper. In some embodiments, an adjustable tail plate attached to the tail end of the hopper adjustably determines a position of the auger in the hopper. The plates, in some aspects, are available separately from the hopper.

### RELATED APPLICATIONS

This application is a non-provisional application which claims the benefits of U.S. Provisional Patent Application No. 63/507,789 filed on Jun. 13, 2023.

### TECHNICAL FIELD

The present invention relates to agricultural equipment. More specifically, the present invention relates to auger hopper systems.

### BACKGROUND

Grain augers are widely used to transport grain (i.e., dried agricultural products) from a lower elevation to a higher elevation. A hopper (or “auger hopper”) is commonly attached to the lower end of a grain auger and the hopper is then positioned under an outlet of a grain storage bin. When the outlet is opened, the grain falls into the hopper and contacts flighting of the auger within the hopper. The shaft of the auger, which supports the auger flighting, rotates. This rotational action moves the grain upwards (i.e., along an axial direction of the auger). The auger shaft and flighting are surrounded by an auger tube having a constant size along its length. When the grain reaches a predetermined higher elevation (typically the top of the auger), the grain leaves the auger tube and is deposited in a new receptacle (e.g., in a grain truck, in a higher container, etc.).

However, although there are numerous auger hoppers on the market, conventional hoppers are not suitable for use with augers of different sizes. That is, there are several sizes and configurations of grain auger tube available (commonly, round tubes of 8-inch diameter; 10-inch diameter; 12-inch diameter; and 13-inch diameter; and “U-trough”-shaped tubes. U-troughs are commonly available to suit augers having outside diameters (“OD”) of 6 inches, 8 inches, 10 inches, and 12 inches, for horizontal or low angle transfers, and, for steeper transfers, U-troughs are commonly available for augers of 12-inch outside diameter and 13-inch outside diameter.

Additional throat plate can be quickly made available for different sizes. Conventional auger hoppers are designed to fit one of these sizes, or, in some cases, to securely fit one size and poorly fit others. (For example, a hopper that fits a 13-inch-diameter auger tube may be used with a 12-inch-diameter auger tube, but the fit may be looser and grain may be wasted. Conventional hoppers have a fixed radius collar and therefore require additional hoppers to service varied augers. Thus, if a farmer has, uses, or needs augers of different sizes (for different grains or different purposes), they must also purchase an entirely separate hopper for each auger.

Thus, there is a need for a hopper system that can be readily used with augers of different sizes, without the disadvantages of prior systems.

### SUMMARY

This document discloses a hopper system including detachable plates suitable for use with grain auger tubes of different sizes. A detachable, generally U-shaped plate is attached to the hopper and receives an auger tube of predetermined size, such that the auger tube makes contact with the U-shaped edge of the plate. The plate is selected from a plurality of plates configured for auger tubes of different sizes. To switch the hopper from one auger to another of a different size, the attached plate is detached from the hopper and a different plate is attached. In some embodiments, the auger extends through a tail end of the hopper and secured outside the hopper. In some embodiments, an adjustable tail plate attached to the tail end of the hopper determines a position of the auger in the hopper. The plates, in some aspects, are available separately from the hopper.

In a first aspect, this document discloses a system comprising: an auger hopper comprising a tube end and a tail end opposite the tube end, wherein said tube end comprises an auger opening for receiving a tube of an auger into the hopper; and a plate selected from at least two different plates, each of said different plates being separately attachable to said hopper at said auger opening and wherein said different plates are configured to receive auger tubes of different sizes, wherein, when said tube of said auger is received in said hopper, a shaft and flighting of said auger are exposed within said hopper.

In another embodiment, this document discloses a system wherein said tail end comprises a tail opening for receiving a securing extension of the auger, and wherein said securing extension is secured at said tail opening such that said tube of said auger is secured in said hopper.

In another embodiment, this document discloses a system wherein said tail opening comprises an opening in a detachable tail plate attached to said hopper at said tail end.

In another embodiment, this document discloses a system wherein a position of said tail plate with respect to a bottom of said hopper is adjustable.

In another embodiment, this document discloses a system wherein said auger tube has a size that is one of: 8-inch diameter; 10-inch diameter; 12-inch diameter; 13-inch diameter; 6-inch outer diameter U-trough; 8-inch outer diameter U-trough; 10-inch outer diameter U-trough; 12-inch outer diameter U-trough; and 13-inch outer diameter U-trough.

In another embodiment, this document discloses a system wherein said plate comprises a sealing strip around a receiving edge of said plate, such that said tube of said auger contacts said sealing strip when said tube of said auger is received in said auger opening.

In another embodiment, this document discloses a system further comprising a sealable cleanout opening at an underside of the hopper.

In another embodiment, this document discloses a system further comprising a skid plate disposed at an underside of the tail end of the hopper.

In another embodiment, this document discloses a system wherein said hopper is formed of aluminum.

In another embodiment, this document discloses a system wherein said skid plate is formed of steel.

In another embodiment, this document discloses a system further comprising a securing mechanism at said tube end for securing said tube of said auger in said hopper.

In a second aspect, this document discloses a kit of parts for assembly into a hopper system, the kit of parts comprising: a plurality of plates, each of said plates being separately attachable to an auger hopper at an auger opening of said auger hopper, wherein at least two of said plurality of plates are configured to receive auger tubes of different sizes; and mounting hardware for attaching one of said plurality of plates to said auger hopper.

In another embodiment, this document discloses a kit of parts wherein said kit of parts is for retrofitting said auger hopper.

In another embodiment, this document discloses a kit of parts wherein said auger hopper is provided as part of said kit of parts.

In another embodiment, this document discloses a kit of parts further comprising a tail plate for attachment to said hopper at a tail opening of said hopper, wherein a position of said tail plate with respect to a bottom of said hopper is adjustable.

In another embodiment, this document discloses a kit of parts wherein said different sizes comprise at least one of: 8-inch diameter; 10-inch diameter; 12-inch diameter; 13-inch diameter; 6-inch outer diameter U-trough; 8-inch outer diameter U-trough; 10-inch outer diameter U-trough; 12-inch outer diameter U-trough; and 13-inch outer diameter U-trough.

In a third aspect, this document discloses a kit of parts for assembly with a hopper system, the kit of parts comprising: at least one plate, said at least one plate being attachable to an auger hopper at an auger opening of said auger hopper, and said at least one plate corresponding to an auger tube of predetermined size.

In another embodiment, this document discloses a kit of parts wherein said kit of parts further comprises mounting hardware for attaching said at least one plate to said auger hopper.

### BRIEF DESCRIPTION OF THE DRAWINGS

The present invention will now be described by reference to the following figures, in which identical reference numerals refer to identical elements and in which:

FIG. 1 is a schematic illustration of a hopper system attached to a grain auger;

FIG. 2A is a schematic illustration of a hopper system according to an aspect of the present invention, when attached to an auger;

FIG. 2B is a top view of the hopper system of FIG. 2A;

FIG. 3 is a schematic illustration of the hopper system of FIG. 2 when detached from an auger;

FIG. 4 is a schematic illustration of the hopper system of FIG. 2 illustrating the plurality of plates;

FIG. 5A is a schematic illustration of a hopper interior according to an embodiment of the present invention;

FIG. 5B is a schematic illustration of a rear of a hopper according to an embodiment of the present invention;

FIG. 6 is a schematic illustration of an underside of a hopper according to an embodiment of the present invention; and

FIGS. 7A to 7E are schematic illustrations of hopper systems according to embodiments of the present invention, with augers of different sizes.

### DETAILED DESCRIPTION

The present invention provides a hopper system, and kits of parts for hopper systems, that is suitable for use with auger tubes of different sizes. An auger tube of a predetermined size is received in a tube opening of a hopper. At the tube opening, a detachable, generally U-shaped plate is attached to the hopper. The plate is specifically configured to tightly receive the auger tube of predetermined size, such that the auger tube makes contact with the U-shaped inner edge of the plate. In some embodiments, a sealing strip is disposed along the U-shaped inner edge of the plate to (reduce) increase friction, provide a snug fit, and mitigate grain loss. The plate is selected from a plurality of plates configured for auger tubes of different sizes. Thus, should the farmer wish to switch the hopper from one auger to another auger of a different size, they simply detach the plate from the tube end of the hopper and attach a different plate that is suitable for the other auger.

As should be clear, the term “grain” as used herein encompasses any and all substances that are suitable for elevation by a grain auger. This includes, without limitation, grains, seeds, and any other suitable particulate matter. Further, in some embodiments, the present invention may be used in non-agricultural contexts and/or for elevating non-agricultural small particulates. The person skilled in the art would be aware of suitable substances and implementations of the present invention.

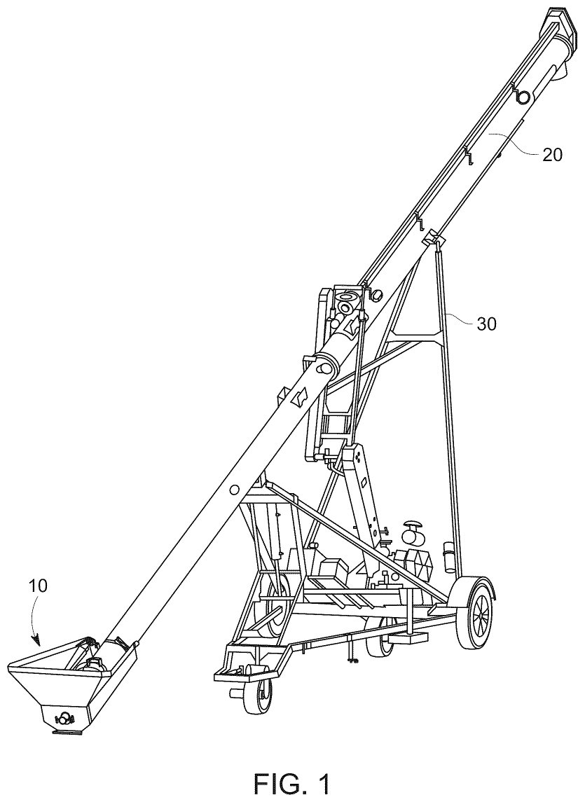

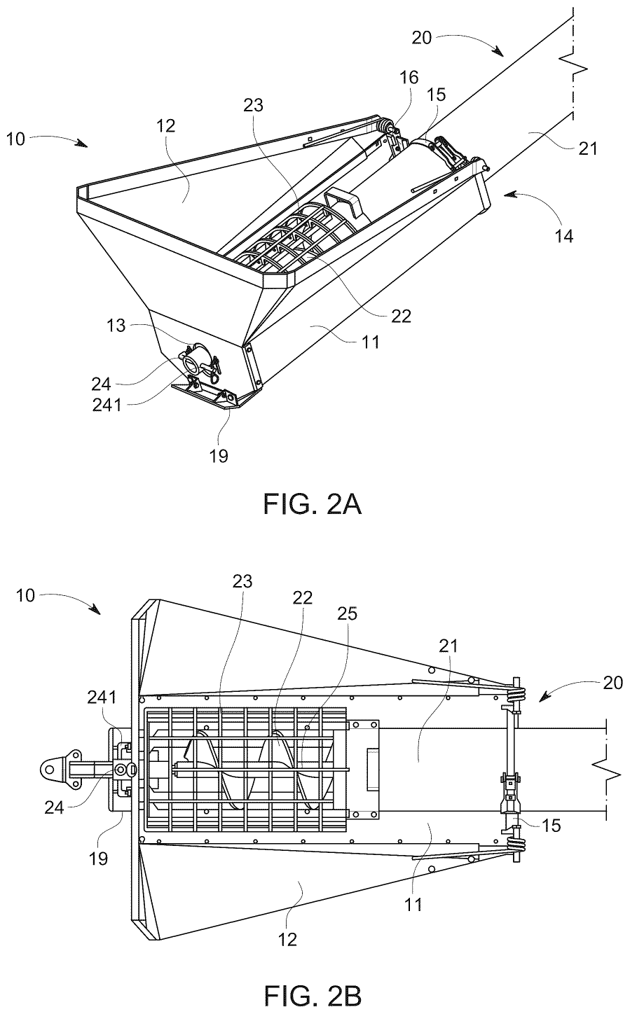

Referring now to FIG. 1, a hopper system 10 is shown attached at the lower end of an auger 20, which is support by a support structure 30. FIG. 2A shows the hopper system 10 in more detail. The auger 20 comprises an auger tube 21 that is received at the tube opening 14 by the attached plate 16. The auger 20 as shown further comprises flighting 22 (i.e., a helical screw blade) disposed around a shaft (not numbered in this figure). As can be seen, the flighting 22 and, in some embodiments, the shaft of the auger 20, may be partially exposed in the hopper, so that the grain may make contact with the flighting 22 and be drawn up into and through the tube 21. That is, the flighting 22 of the auger 20 is accessible to material (i.e., grain) within the hopper).

Further, in some embodiments (including that shown in FIG. 2A), the auger 20 further comprises a cage 23. The cage 23 protects against accidents when the auger shaft is in motion. As should be understood, such a cage 23 may be present on some augers and may be absent from others. Additionally, in some embodiments, a cage or other protective mechanism may be part of the hopper itself, rather than part of the auger. Further, in some embodiments, components of the auger and components of the hopper system 10 may cooperate to provide a cage or similar protective mechanism.

The hopper of the hopper system 10 shown in FIG. 2A comprises a base 11 and sides 12. (As should be clear, of course, in some embodiments, the hopper may be formed as a single piece with no distinction between the sides 12 and base 11, or may have a configuration, shape, or dimensions other than those shown in this figure. Many potential hopper configurations, shapes, and dimensions are known in the art, and nothing in this description or figure should be construed as limiting any of the above.)

In the embodiment shown in FIG. 2A, the auger 20 further comprises a securing extension 24 that extends through a tail opening 13 of the hopper. The securing extension 24 is releasably secured outside the hopper (for example, using the illustrated pin 241), and thereby helps to secure the auger 20 within the hopper. Of course, many releasable securing mechanisms are known in the art and may be used in the present invention. For example, in some embodiments, straps, releasable adhesives, and/or removable fasteners (e.g., nuts and bolts, screws, nails, etc.) may be used to secure the auger at the tail end of the hopper. Further, in some embodiments and/or implementations, permanent or semi-permanent attachment mechanisms or methods, such as welding, may be used. Other attachment methods may be developed as necessary or desired for different models of auger tubes and/or different implementations. Further, in some embodiments, the end of the auger may be secured within the hopper, rather than extending through a tail opening 13 and being secured outside the hopper. Further, in some embodiments, no securing mechanism is present at the tail end. All such configurations and securing mechanisms are within the scope of the present invention.

The auger tube 21 is, in some embodiments, secured at the tube end of the hopper (i.e., the end that is opposite the tail end). That is, the auger tube 21 is received by the plate 16 at the tube opening 14 and, in some embodiments, an additional securing mechanism 15 holds the auger tube 21 in place. In the embodiment shown in FIG. 2, the securing mechanism 15 comprises a ratchet strap that fits around the auger tube 21. In other embodiments, the securing mechanism 15 comprises different securing mechanisms/fasteners, such as tie-down straps or ropes, bungee cords or other elastic/elasticated cords, releasable adhesives, removable fasteners, etc. Further, in some embodiments, the securing mechanism 15 cooperates with one or more protrusions, recessions, or other securing locations on the auger tube 21 to enhance the security of the auger tube 21 within the hopper.

Additionally, in some embodiments, as will be further discussed below, the hopper system 10 comprises a skid plate 19 disposed at an underside of the tail end of the hopper. The skid plate 19 protects the hopper and enables the hopper to be slid along the ground, for example to be positioned under a grain bin. As such, the skid plate 19 is preferably formed of a durable material. For example, in some embodiments, the skid plate 19 is formed of steel, which may include plate steel or cast steel, and/or steel alloys. In other embodiments, the skid plate 19 is formed of another strong metal that is not readily deformable. For example, in some embodiments, the skid plate 19 may comprise a strong plastic, and may, in some embodiments, be entirely or partially 3D-printed.

In contrast, the hopper itself is, in some embodiments, formed of a lightweight material. For example, in some embodiments, the hopper is formed of aluminum. Additionally, in some embodiments, different parts of the hopper are formed of different materials. For example, in embodiments in which the hopper has expandable sides, the expandable sides may be made of canvas or leather while other parts of the hopper, such as the base, are made from metal.

However, in some embodiments, the hopper and the skid plate 19 may be formed of a same material or as a single piece. For example, the hopper and the skid plate 19 may be entirely formed of plastic or of steel.

FIG. 2B is a top-down view of the hopper system 10 attached to an auger 20. As can be seen, the flighting 22 comprises a helical blade disposed around the auger shaft 25. The outside diameter (OD) of the auger, a common measurement of auger size, is the distance between the outer edges of the flighting without accounting for longitudinal distance, i.e., when the auger is viewed end-on. The auger tube 21 extends into the hopper and is secured (in the embodiment shown) at both the tail end and the tube end.

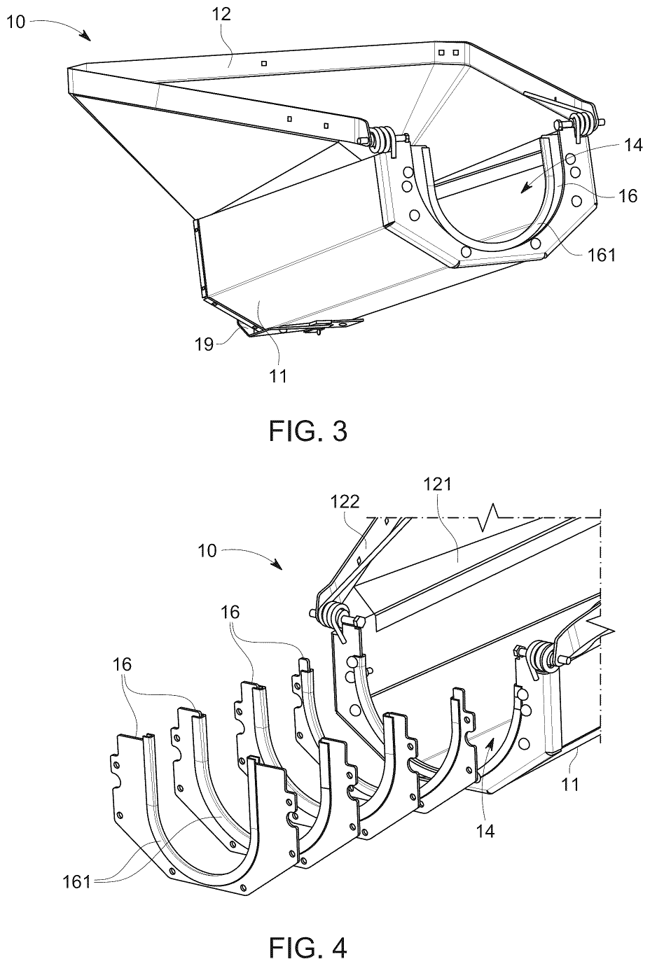

Referring now to FIG. 3, a hopper system 10 is shown with a single plate 16 attached and without an auger tube 21. The view in FIG. 3 (from the tube end of the hopper) more clearly shows the tube opening 14 and the plate 16. As can be seen, the plate 16 has a generally U-shaped inner edge. The plate 16 may be made of a same material as the hopper or of a different material. Further, as mentioned above, in some embodiments such as the embodiment shown, a sealing strip 161 is disposed along the generally U-shaped inner edge. The sealing strip 161 may comprise weatherstripping, foam, rubber, or any other material suitable for reducing friction and assisting with a tight fit between the plate 16 and the auger tube 21. As well, the sealing strip 161 may comprises a continuous strip of sealing material or a plurality of smaller strips and/or pieces of sealing material. (Note that a continuous seal is, however, generally preferred to mitigate grain loss.)

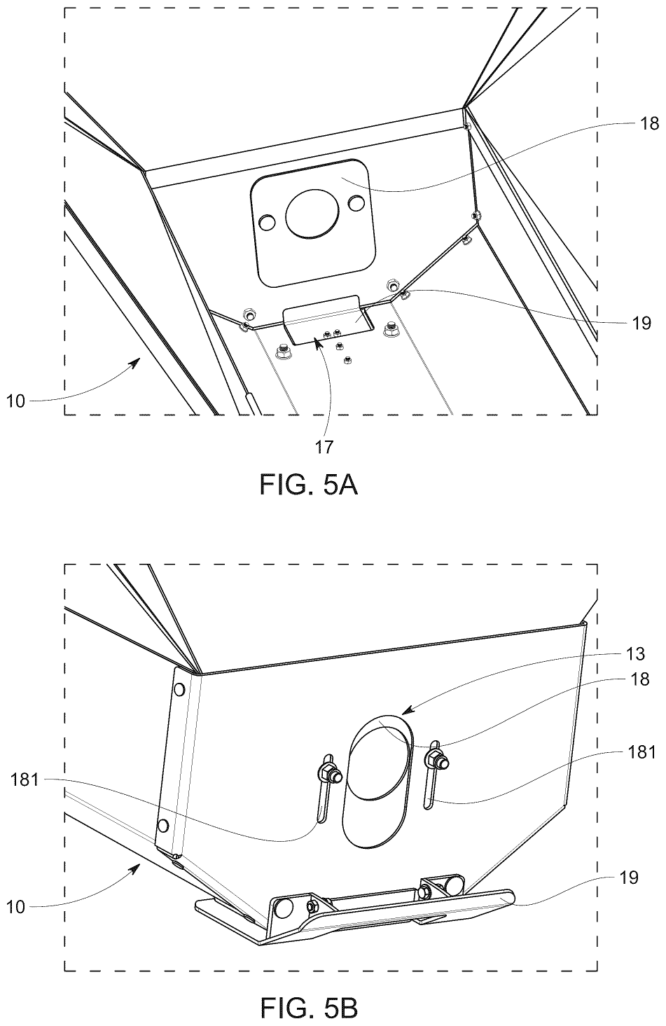

FIG. 4 shows a hopper system 10 including a plurality of plates 16. (Note that the hopper depicted in this image has a base 11, sides 121, and sidearms 122 for controlling a depth of the hopper. In some embodiments, the hopper sides 121 are flexible and attached to the sidearms 122 via a spring or other tension mechanism, which allows the edge of the hopper to be lowered and raised, thereby facilitating access to low clearance locations such as hopper bin bottoms and truck bottom hoppers. Again, many such hopper configurations are known in the art, and nothing in these figures should be considered to limit the hopper configuration of the present invention with respect to sides, base, configuration, shape, or dimensions.) As can be seen, the tube opening 14 itself has a generally U-shaped inner edge around which a sealing strip 161 may be disposed. That is, depending on the size of the desired auger tube 21, part of the inner edge of the tube opening 14 may also contact the auger tube 21, and may have a sealing strip 161 applied thereto. For example, if an auger tube 21 is larger than a largest plate size, the auger tube 21 may rest directly on the inner edge of the tube opening 14.

The plurality of plates 16 shown in FIG. 4, as can be seen, comprises four plates with U-shaped inner edges of varying size. Each plate 16 is thus suited for an auger tube 21 of a corresponding size. As should be understood, the number and dimensions of the plates 16 depends on the embodiment and in no way limits the invention. In the embodiment shown, attachment points for attaching the plate 16 to the hopper are preferably at the same positions on each of the plurality of plates (i.e., the holes around the outer edges of the plates 16). However, in some embodiments and/or for unusual auger tube dimensions, the attachment points may be at different positions on different plates.

Further, the plates 16 may be attached to the hopper using any suitable attachment mechanism known in the art. As the plates 16 are preferably interchangeable by the end user, such attachment mechanisms preferably include readily available and readily releasable fasteners (including without limitation ties, straps, adhesives, screws, nuts and bolts, nails, and other attachment mechanisms). The person skilled in the art would be able to select appropriate attachment mechanisms for any specific embodiment.

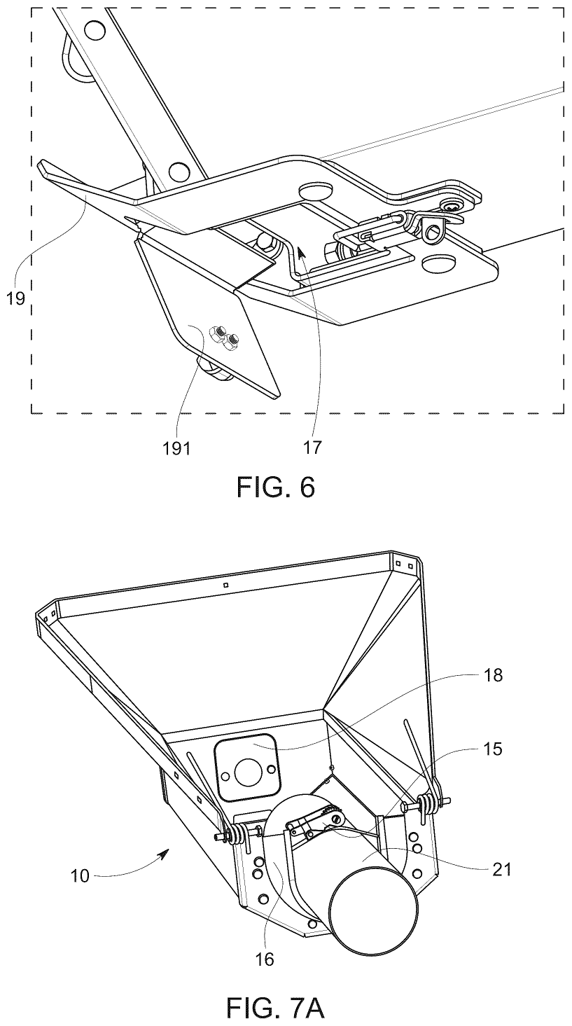

FIG. 5A shows an interior view of a hopper system 10 (with neither an auger tube 21 nor grain). As should be understood, after use, some amount of grain may remain in the hopper and need to be removed therefrom. To avoid scooping out the remaining grain or tilting the hopper, a sealable cleanout opening 17 may be included in the underside of the hopper (i.e., in the hopper base or floor). When the cleanout opening 17 is covered, the cover acts as the floor or base. When the cleanout opening 17 is unsealed (i.e., the cover is removed), the remaining grain may drain through the cleanout opening 17. The cover may be hinged to the hopper, slidably removable from the cleanout opening 17, or attached to the hopper using fasteners and/or adhesives. Further, in some embodiments such as that shown in FIG. 5A, the cover may be an inner side of the skid plate 19.

FIG. 5A also shows a detachable tail plate 18 that attaches to the tail end of the hopper in some embodiments. As can be seen, the tail plate 18 comprises an opening. The opening aligns with the tail opening 13 such that the securing extension passes from the inside of the hopper to the outside of the hopper when the auger is received in the hopper. As should be clear, in embodiments where the auger is secured within the hopper at the tail end, or is not secured at the tail end, the tail end of the hopper would preferably not have an opening, nor would the tail plate 18 (if used).

The tail plate 18 is, in some embodiments, vertically adjustable with respect to the bottom of the hopper. For example, FIG. 5B shows the tail plate 18 of FIG. 5A from the outside of the hopper. As can be seen, the opening in the tail plate 18 aligns with the tail opening 13. Further, the opening in the tail plate 18 is preferably smaller than the tail opening 13, to thereby reduce potential movement of the securing extension 24 and, by extension, of the auger 20. As can be seen, in some embodiments, the tail opening is oval-shaped and may be characterized as elongated.

This allows augers of different sizes to be secured at different positions and angles. Augers are preferably positioned close to the bottom of the hopper, to reduce the amount of grain loss, and thus the adjustable tail plate 18 allows different augers to be positioned in different ways. In some embodiments, however, a tail plate 18 may be non-adjustable (i.e., permanently attached) or may not be used (as noted above).

In the embodiment shown, the tail plate 18 is secured in its vertical position by way of two attachment tracks 181. Threaded bolts extending from the tail plate 18 are fitted through each track 181 and each bolt is secured using a washer and a nut. By loosening the attachment mechanisms, the positioning of the tail plate 18 can be moved vertically relative to the tail opening 13. The attachment mechanisms can then be tightened to secure the tail plate 18. Of course, however, numerous other attachment mechanisms would be evident to the person skilled in the art, including without limitation other releasable fasteners, ties, adhesives, etc.

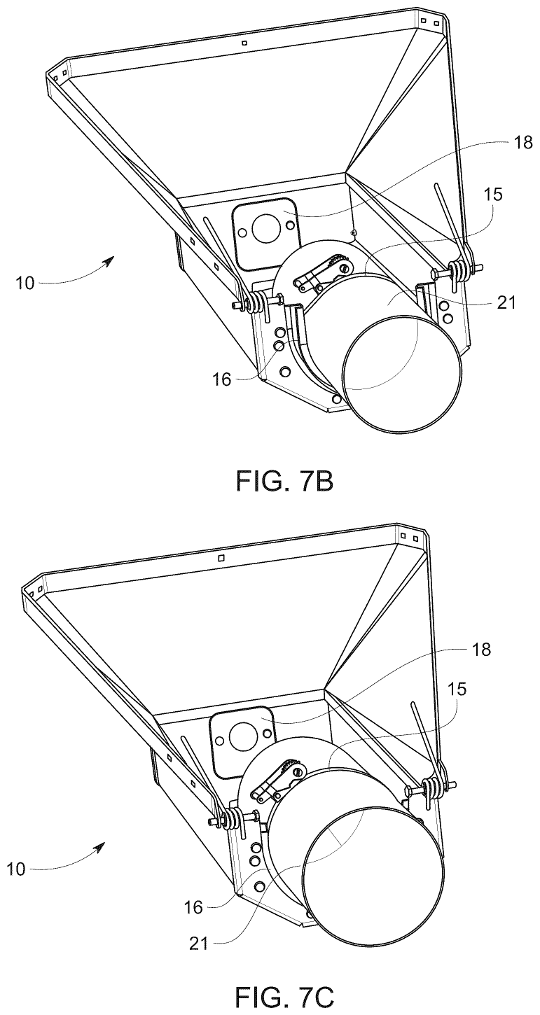

FIG. 6 shows an underside of the hopper with the cleanout opening 17 uncovered. As can be seen, in this embodiment, the cover for the cleanout opening 17 comprises a portion 191 of the skid plate 19. However, as described above, the cover may have any suitable form and be attached in any suitable way.

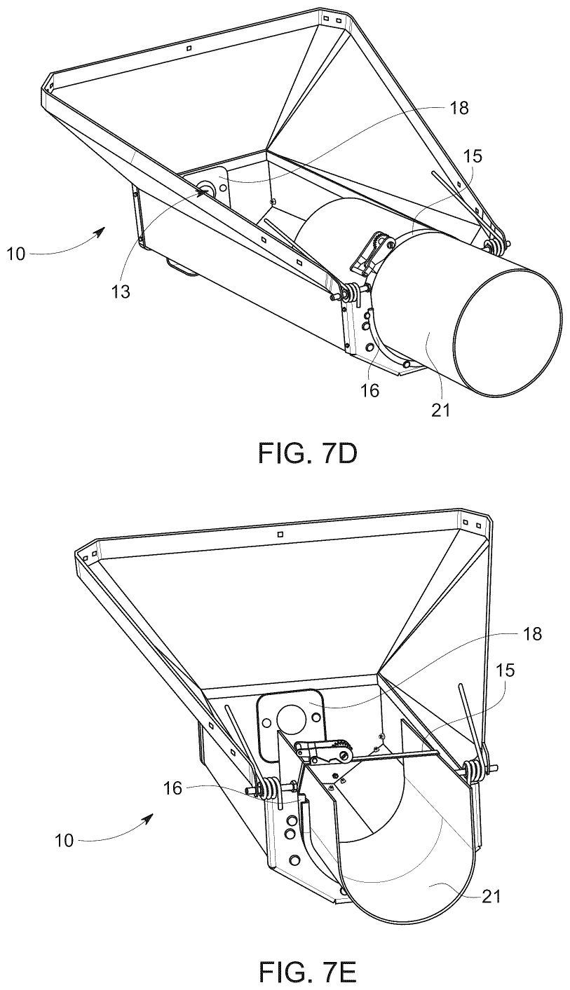

FIGS. 7A to 7E show hopper systems 10, each having a plate 16 of a different size attached at the tube opening 14 and each having a corresponding auger tube 21 secured in the hopper. FIG. 7A shows an 8-inch auger tube 21 and plate; FIG. 7B shows a 10-inch auger tube 21 and plate; FIG. 7C shows a 12-inch auger tube 21 and plate; FIG. 7D shows a 13-inch auger tube 21 and plate; and FIG. 7E shows a “U-trough”-type auger tube 21 and a plate configured for such an auger tube 21.

In some aspects, the various pieces of the hopper system 10 may be provided in an assembled form. In other aspects, separate pieces may be available separately. For example, a hopper system 10 may be available that includes a hopper with an already-attached plate 16, and with an associated plurality of other plates 16 for use with other auger tubes. In other cases, one or more plates 16 may be available alone, for assembly with an already existing hopper or hopper system 10. Further, kits of parts comprising a plurality of plates 16 and a hopper, for assembly into a hopper system 10, may be available. Further, in some cases, existing hoppers may be retrofitted for use with the plate(s) 16 and/or tail plate 18. Further, suitable mounting hardware (i.e., attachment mechanisms of various types) may be available as part of any of the above kits of parts and/or separately. All such aspects are within the scope of the present invention.

As used herein, the expression “at least one of [x] and [y]” means and should be construed as meaning “[x], [y], or both [x] and [y]”.

A person understanding this invention may now conceive of alternative structures and embodiments or variations of the above all of which are intended to fall within the scope of the invention as defined in the claims that follow.

We claim:

1. A system comprising:
an auger hopper comprising a tube end and a tail end opposite the tube end, wherein said tube end comprises an auger opening for receiving a tube of an auger into the hopper; and
a plate selected from at least two different plates, each of said different plates being separately attachable to said hopper at said auger opening and wherein said different plates are configured to receive auger tubes of different sizes,
wherein, when said tube of said auger is received in said hopper, flighting of said auger is accessible to material within said hopper.

2. The system according to claim 1, wherein said tail end comprises a tail opening for receiving a securing extension of the auger, and wherein said securing extension is secured at said tail opening such that said tube of said auger is secured in said hopper.

3. The system according to claim 2, wherein said tail opening comprises an opening in a detachable tail plate attached to said hopper at said tail end.

4. The system according to claim 3, wherein a position of said tail plate relative to a bottom of said hopper is adjustable.

5. The system according to claim 1, wherein said auger tube has a size that is one of: 8-inch diameter; 10-inch diameter; 12-inch diameter; 13-inch diameter; 6-inch outer diameter U-trough; 8-inch outer diameter U-trough; 10-inch outer diameter U-trough; 12-inch outer diameter U-trough; and 13-inch outer diameter U-trough.

6. The system according to claim 1, wherein said plate comprises a sealing strip around a receiving edge of said plate, such that said tube of said auger contacts said sealing strip when said tube of said auger is received in said auger opening.

7. The system according to claim 1, further comprising a closeable cleanout opening at an underside of the hopper.

8. The system according to claim 1, further comprising a skid plate disposed at an underside of the tail end of the hopper.

9. The system according to claim 1, wherein said hopper is formed of aluminum.

10. The system according to claim 8, wherein said skid plate is formed of at least one of steel and steel alloy.

11. The system according to claim 1, further comprising a securing mechanism at said tube end for securing said tube of said auger in said hopper.

12. A kit of parts for assembly into a hopper system, the kit of parts comprising:
a plurality of plates, each of said plates being separately attachable to an auger hopper at an auger opening of said auger hopper, wherein at least two of said plurality of plates are configured to receive auger tubes of different sizes; and
mounting hardware for attaching one of said plurality of plates to said auger hopper.

13. The kit of parts according to claim 12, wherein said kit of parts is for retrofitting said auger hopper.

14. The kit of parts according to claim 12, wherein said auger hopper is provided as part of said kit of parts.

15. The kit of parts according to claim 12, further comprising a tail plate for attachment to said hopper at a tail opening of said hopper, wherein a position of said tail plate with respect to a bottom of said hopper is adjustable.

16. The kit of parts according to claim 12, wherein said different sizes comprise at least one of:
8-inch diameter; 10-inch diameter; 12-inch diameter; 13-inch diameter; 6-inch outer diameter U-trough; 8-inch outer diameter U-trough; 10-inch outer diameter U-trough; 12-inch outer diameter U-trough; and 13-inch outer diameter U-trough.

17. A kit of parts for assembly with a hopper system, the kit of parts comprising:
at least one plate, said at least one plate being attachable to an auger hopper at an auger opening of said auger hopper, and said at least one plate corresponding to an auger tube of predetermined size.

18. The kit of parts according to claim 17, wherein said kit of parts further comprises mounting hardware for attaching said at least one plate to said auger hopper.
